(19) United States
(12) Patent Application Publication
(10) Pub. No.: US 2007/0223677 A1
(43) Pub. Date: Sep. 27, 2007

(54) Multi-party communication system, terminal device, multi-party communication method, program and recording medium

(75) Inventor: Yoshihiro Ono, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/727,135

(22) Filed: Mar. 23, 2007

(30) Foreign Application Priority Data
Mar. 24, 2006 (JP) 083685/2006

(51) Int. Cl. H04M 3/42

(52) U.S. Cl. 379/202.01

(57) ABSTRACT

The present invention provides a multi-party communication system in which the speaking party can be identified aurally and the speech contents can be accurately transmitted to the party at the receiving terminal. A multi-party communication server and a plurality of terminal devices with a communication function make up the multi-party communication system. Each terminal device with the communication function includes a speech right management unit, a speaking party name output unit and a buffer unit. The speaking party name output unit outputs the voice data of the speaking party identification information such as the name of the speaking party. The buffer unit accumulates the speech voice of the user as voice data. The speech right management unit controls the buffer unit to produce an output after the speaking party output unit. The speech right management unit issues a request to cancel the right to speak after completion of the output of the speech voice data.

### BACKGROUND OF THE INVENTION

1. Field of the Invention

This invention relates to a multi-party communication system, a terminal device with a communication function, a multi-party communication method, a program and a recording medium, or in particular to a technique to identify a person who is speaking based on voice and transmit the contents of conversation to the other parties in a multi-party communication system to communicate with each other.

2. Description of the Related Art

Conventionally, a telephone conference and a Push-to-Talk system are known as a group conversation system in which a plurality of users communicates vocally with each other. In all the systems, terminals are connected with each other through a network, the group conversation is conducted in such a manner that the voice of a user is transferred to the other terminals as a voice signal, and the terminal that has received the voice signal produces the voice through equipment such as a speaker.

Normally, in the telephone conference or the Push-to-Talk service, as described above, only the voices are exchanged, and a user in conversation identifies another party based only on the features of voice such as tone and pitch. However, voices through a sound reinforcement device like a speaker are somewhat different from the original voice that you hear face-to-face, and the voices are not easily identified when noises exist. Also, when many persons take part in a conversation, it becomes more difficult to identify the speaking party.

In such a case, a user may give his/her name before he/she talks on the subject and the user him/herself supports operations of a system. If a terminal of a user has a display, the speaking party may be visually identified. For example, when a user of a Push-to-Talk terminal achieves the right to speak, information concerning who has achieved the right to speak is sent to each terminal separate from voice data, and the name of the user is displayed.

Also, document 1 (Japanese Patent Application Laid-Open No. 10-215331) discloses a technique for easily identifying the speaking party in a voice conference system, wherein the speech voice is transmitted from a transmitting terminal with the identification information such as a name, and reproduced at a receiving terminal while the name of the speaking party is notified based on the identification information.

Document 2 (Japanese Patent Application Laid-Open No. 11-136369) proposes a multi-point connecting voice control device for identifying the speaking party among a plurality of simultaneous connected users, and providing the voice service using the identification result. This device comprises means for visually displaying the user identifier on the screen, and means for determining a speaking party when the voice level remains higher than a predetermined threshold over a predetermined length of time.

Also, document 3 (Japanese Patent Application Laid-Open No. 2004-118314) discloses a TV conference system in which the speaking party can be specified and selectively captured based on the information on an image. In this system, the anticipated behavior is detected from the motion of lips in the face images of the participants thereby to specify a participant who is about to speak.

In a noisy environment, since a speaker or handset of a terminal must be held against the ear to listen to the conversation, the user cannot see the display. Also, in a conference with a vast amount of papers or documents distributed, participants may consume most of the time in checking the documents without looking up at the screen. Further, the screen display of such information may be not always convenient for a visually-challenged person.

In the method disclosed in document 1 for notifying the name of the speaking party based on the identification information attached to his/her voice, the name and/or the portrait is displayed on the screen or the name is vocally notified. It is unknown, however, at what timing the voice of the speaking party is output and how the name of the speaking party is output vocally from the speaker without hampering the speaker output of the conversation. The methods disclosed in documents 2 and 3 employ the visual identification of the speaking party.

### SUMMARY OF THE INVENTION

It is an objective of this invention to provide a multi-party communication system in which the speaking party can be visually identified and the contents of conversation can be accurately transmitted to the other parties.

In order to achieve this objective, according to one aspect of the invention, there is provided a multi-party communication system comprising a multi-party communication server for controlling the speech right acquisition request from each terminal device with a communication function and a plurality of the terminal devices with the communication function for communication among a multiplicity of users with the permission of the speech right acquisition from the multi-party communication server, wherein the terminal devices with the communication function each include identification information output section that outputs the identification data of the speaking party as a voice data, speech content accumulation section that accumulates contents of talk converted from voice into voice data, and speech right management section that makes a request to acquire or cancel the right to speak, and wherein the speech right management section controls the timing of the output from the identification information output section, the accumulation by the speech content accumulation section and the speech right cancel request.

In the multi-party communication system including the multi-party communication server and a plurality of the terminal devices with the communication function, each terminal device with the communication function has a unique configuration. Specifically, the speech content accumulation section is controlled to produce an output after the output of the identification information output section in such a manner that the identification information output section outputs the voice data for generating the speaking party identification information such as a name of the speaking party as voice at the receiving terminal, the speech content accumulation section accumulates voice as voice data, and the speech right management section issues the identification information voice before the speech voice at the receiving terminal. Also, the speech right management section issues the speech right cancel request after complete output of the speech voice data.

The speaking party name output unit accumulates the name of the speaking party as voice data in advance, and may output the speaking party name voice data as required. Alternatively, the speaking party name voice is converted from the character string to the voice data by voice synthesis, which voice data may be output after conversion.

In view of the fact that the identification information output section outputs the speaking party identification information such as the name of the speaking party as voice data, the speaking party identification information can be obtained by voice at the receiving terminal. Also, in view the fact that the speech content accumulation section accumulates the speech voice and the speech right management section controls the speech content accumulation section to output contents of talk voice data after output of the identification information voice data from the identification information output section, the speech voice can be prevented from being erased by the identification information voice. Also, in view of the fact that the speech right management section makes a request to cancel the right to speak after complete output of the speech voice data, the speech contents are prevented from being lost before finishing the speech due to the speech of other users.

According to another aspect of the invention, there is provided a terminal device with a communication function used with a multi-party communication system comprising a multi-party communication server for controlling the speech right acquisition request from each terminal device with the communication function and a plurality of the terminal devices with the communication function for conducting speech among a multiplicity of users with the permission of speech right acquisition from the multi-party communication server, wherein the terminal devices with the communication function each include identification information output section that outputs the speaking party identification data as voice data, speech content accumulation section that accumulates the contents of talk converted from voice into voice data, and a speech right management section that makes a request to acquire or cancel the speech right, and wherein the speech right management section controls the timing of the output from the identification information output section, the accumulation by the speech content accumulation section and the speech right cancel request.

According to still another aspect of the invention, there is provided a multi-party communication method for a multi-party communication system including a multi-party communication server for controlling the speech right request from each terminal device with a communication function and a plurality of the terminal devices with the communication function for carrying out the multi-party communication with the permission to acquire the speech right from the multi-party communication server, the method comprising an identification information output step of outputting the identification information on the speaking party as voice data, a speech content accumulation step of accumulating the speech contents converted from voice into voice data, and a speech right management step of requesting the acquisition of the speech right and cancellation of the speech right acquired, wherein the speech right management step controls the timing of the output of the identification information output step, the accumulation in the speech content accumulation step and the speech right cancellation request.

Also, this invention may provide a program for causing the terminal devices to execute the multi-party communication method.

Further, this invention may provide a recording medium for recording the program.

According to this invention, there is provided a multi-party communication system in which the speaking party can be aurally identified and the contents of talk can be accurately transmitted to receiving parties.

### BRIEF DESCRIPTION OF THE DRAWINGS

FIG. 1 is a diagram showing the configuration of a multi-party communication system;

FIG. 2 is a function block diagram showing the configuration of a terminal device;

FIG. 3 is a diagram for explaining the operation of the terminal device;

FIG. 4 is a diagram showing the configuration of the speaking party name output unit of the terminal device; and

FIG. 5 is a diagram showing the configuration of the speaking party name output unit of the terminal device.

### DESCRIPTION OF THE PREFERRED EMBODIMENTS

Preferred embodiments are explained below with reference to the drawings.

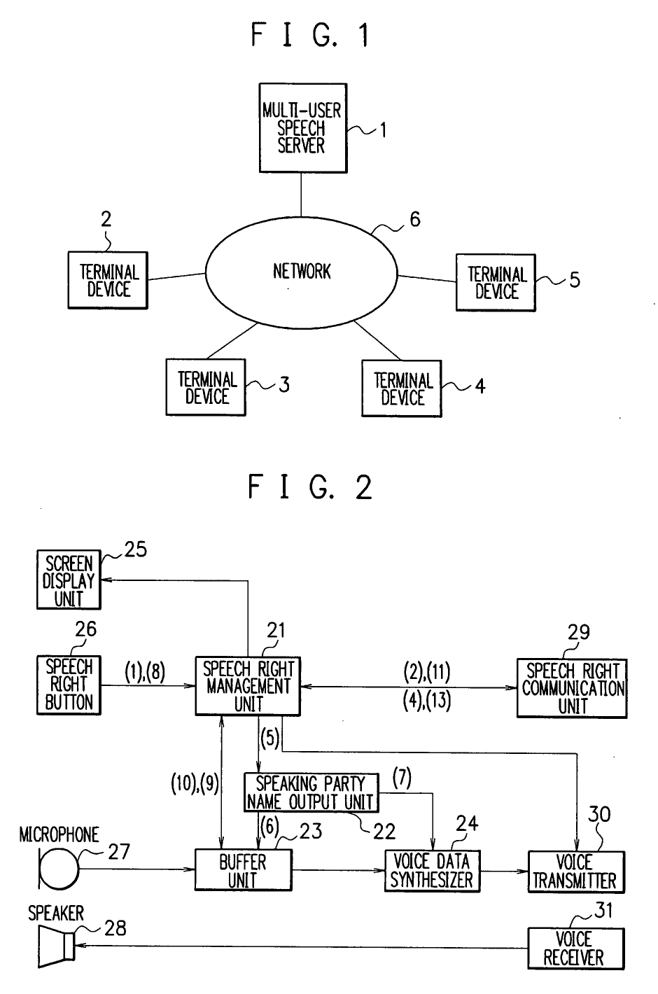

FIG. 1 is a diagram showing the configuration of a multi-party communication system. The multi-party communication system comprises a multi-party communication server 1 and a plurality of terminal devices 2 to 5 that communicate through a network 6. In the multi-party communication system, users of the terminal devices 2 to 5 can carry out conversation each other.

The server 1 regulates and controls procedures of obtaining and canceling the right to speak of the terminal devices 2 to 6, and controls voice data communication. The terminal devices 2 to 5 carry out multi-party communication under the control of the server 1. As described in detail later, in the multi-party communication system according to this embodiment, only the terminal device that has acquired the right to speak from the server 1 can transmit voice data to other terminal devices, while the other terminal devices that have not acquired the right to speak cannot transmit voice data. In other words, only the user who has requested for acquisition of the right to speak and has been granted the right or allowed to talk can transmit information to other users.

FIG. 2 is a function block diagram showing the configuration of one of the terminal devices 2 to 5 shown in FIG. 1. A terminal device with a communication function includes a speech right management unit 21, a speaking party name output unit 22, a buffer unit 23, an voice data synthesizer 24, a display unit 25, a speech right button 26, a microphone 27, a speaker 28, a speech right communication unit 29, a voice transmitter 30 and a voice receiver 31.

The unit 21 holds information on a user who currently has the right to speak for the group conversation, and manages speech requests and speech right requests from users, while transferring the information on the user having the right to speak to the display unit 25. Also, once a user acquires the right to speak, the unit 21 sends instructs the voice transmitter 30 to send voice data, and instructs the unit 22 to output a name of the speaking party.

The unit 22 receives the instruction from the unit 21 and outputs voice data of the speaking party's name, while transmitting an instruction to the buffer unit 23 to begin accumulating voice data inputted from the microphone 27. Upon complete output of the voice data of the speaking party's name, an instruction is transmitted to the buffer unit 23 to output the speech voice data.

The buffer unit 23 accumulates the voice data of the voice acquired from the microphone 27, and upon receipt of an output instruction from the unit 22, outputs the accumulated voice data. The data is output according to, for example, the FIFO (first-in-first-out) scheme.

The synthesizer 24 synthesizes the speaking party name voice data from the unit 22 with the voice data from the buffer unit 23 and transfers the result of synthesis to the voice transmitter 30.

The display unit 25 displays the information of the user currently having the right to speak for the group conversation. The speech right button 26 is depressed by a user trying to speak and transfers the signal requesting the unit 21 to acquire the right to speak.

The microphone 27 inputs the voice of the user to the terminal device with the communication function, and converts the voice into electrical signals. The speaker 28 converts the voice data of other terminal users from the voice receiver 31 into voice and outputs the voice to the receiving terminal.

The unit 28 exchanges signals for controlling the right to speak with the server 1 (FIG. 1). Specifically, the speech right acquisition request signal received from the unit 21 is transferred to the server 1. Or conversely, the speech right acquisition signal of other terminals received from the server 1 is transferred to the unit 21.

The voice transmitter 30 receives a voice transmission instruction from the unit 21 and transfers the voice data to the server 1. The voice receiver 31 transmits the voice data received from the server 1 to the speaker 28.

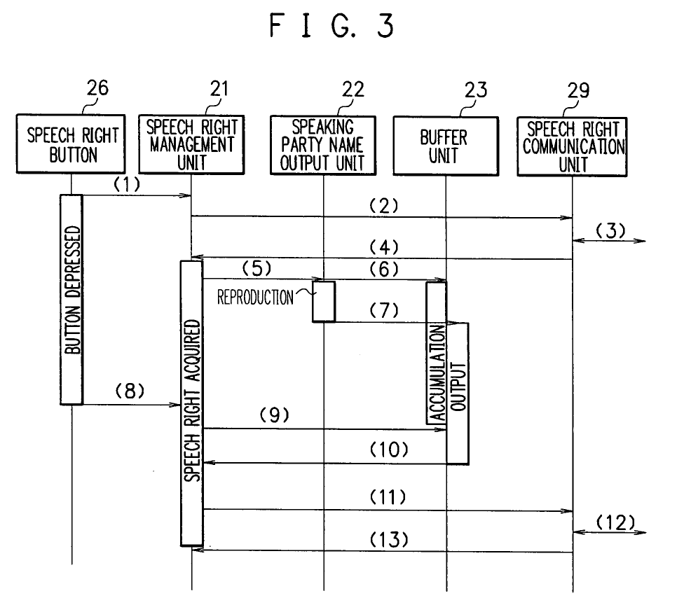

Next, the process flow from the speech right acquisition request to the end of speech is explained. FIG. 3 is a sequence diagram showing the flow of an operation in a terminal device. The numerals in the parentheses beside arrows in FIG. 2 correspond to those in FIG. 3.

A user who wishes to speak is required to acquire the right to speak and first depresses the button 26. Upon depression of the button 26, a button depression start signal is transmitted to the unit 21 (arrow (1)).

When users have yet to acquire the right, the unit 21 issues a speech right acquisition request signal to the unit 29 (arrow (2)). Then, the unit 29 exchanges speech right control signals with the server 1 (arrow (3)), and the unit 21 is finally notified that the right is granted to a user who has issued the request signal (arrow (4)).

Then, the unit 21 issues a request signal to output the speaking party voice data to the unit 22 (arrow (5)). The unit 22 issues an accumulation start request signal for voice data to the buffer unit 23 (arrow (6)). The unit 22 outputs the speaking party voice data, and upon completion of output, issues an output completion signal of the speaking party name voice data to the buffer 23 (arrow (7)).

The buffer unit 23, upon receipt of the accumulation start request signal (arrow (6)), starts to accumulate the voice data, and upon receipt of the output completion signal (arrow (7)), outputs the accumulated voice data in the order of accumulation. As a result, the speech voice data output from the buffer 23 is delayed by the length of the speaking party name voice data output by the unit 22.

After that, the user who has finished the speech cancels the depression of the button 26, and the button depression end signal is sent to the unit 21 (arrow (8)). The unit 21, upon receipt of the button depression end signal (arrow (8)), sends an accumulation end request signal to the buffer 23 (arrow (9)).

Then, the buffer unit 23, upon receipt of the accumulation end request signal (arrow (9)), ends the accumulation of the voice data and continues to output the remaining accumulated voice data. Upon completion of output of the voice data accumulated by the buffer unit 23, the speech voice data output completion signal (arrow (10)) is sent to the unit 21.

The unit 21, upon receipt of the output completion signal (arrow (10)), transmits the speech right cancel request signal (arrow (11)) to the unit 29. The unit 29, upon receipt of the speech right cancel request signal, exchanges speech right control signals (arrow (12)) for canceling the speech right with the server 1, and the unit 21 is notified that the speech right for the terminal user who has issued the request signal has been canceled (arrow (13)).

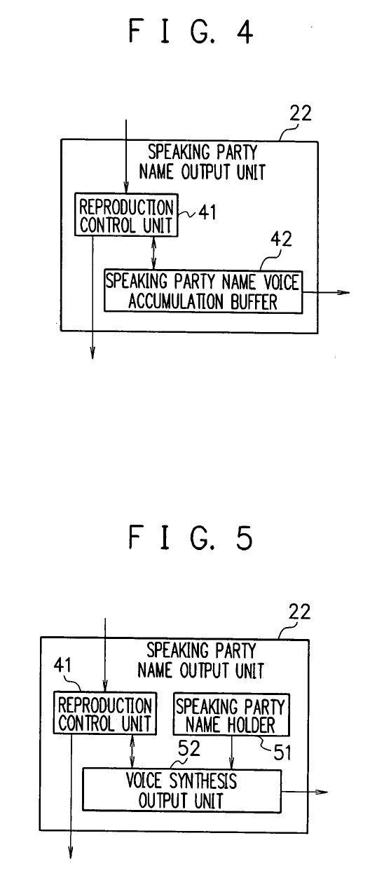

The unit 22, as shown in FIG. 4, may include a speaking party name voice accumulation buffer 42 and a reproduction control unit 41. The buffer 42 stores voice data (accumulated in advance) and the unit 41 controls the voice data and outputs the data as speaking party speech data. Or, the unit 22, as shown in FIG. 5, may include the unit 41, a speaking party name holder 51 and a voice synthesis output unit 52. The unit 51 stores a name of the speaking party in the form of characters or the like. The unit 52, controlled by the unit 41, synthesizes the data stored in the unit 51 into voice data and outputs the voice data.

The objective of this invention can be achieved also by a configuration in which a computer readable recording medium, i.e. a storage medium having recorded a program code of software for realizing the functions of the embodiments described above is supplied to each terminal device, and the program code stored in the storage medium is read and executed by the computer (CPU) of the terminal device.

In this case, the program code read from the recording medium implements the functions of the embodiments described above, and the storage medium for storing the program code constitutes a part of the invention.

The storage medium includes a floppy disk (registered trademark), a hard disk, an optical disk, a magnetooptic disk, a CD-ROM, a CD-R, a nonvolatile memory card, a ROM or a magnetic tape.

The embodiments described above are preferred ones, to which the scope of the invention is not limited, and the invention can be carried out with various modifications within the scope not departing from the spirit of the invention.

According to the embodiments described above, the speaking party's name is transmitted automatically when the terminal user begins speaking. Therefore, other users participating in the group conversation can know the name of the speaking party even without a display.

Also, according to the embodiments described above, the output of the speech data of the terminal user is delayed by the time length during the output of the speaking party name voice data, and therefore, the contents of the talk of the terminal user can be transmitted without any loss to the participants of the group conversation.

Further, the accumulated voice data are output after completion of output of the speaking party name voice data, and therefore, an arbitrary speaking party name voice can be used.

Also, the speech right is canceled not at the time of ending the button depression but after the completion of output of the accumulated speech voice data. Therefore, the whole of speech of each terminal user can be transmitted to the participants of the group conversation.

1. A multi-party communication system comprising:
a plurality of terminal devices;
a multi-party communication server that controls a speech right acquisition request from a plurality of terminal devices; and
wherein the terminal devices each include
an identification information output section that outputs identification information of a speaking party as voice data,
a speech content accumulation section that accumulates contents of talk as data converted from voice, and
a speech right management section that makes a request to acquire a right to speak and a request to cancel the right to speak, and
wherein the speech right management section controls timing of: output from the identification information output section; accumulation by the speech content accumulation section; and the request to cancel the right to speak.

2. The multi-party communication system according to claim 1,
wherein the speech right management section performs a control operation in such a manner that after a permission to obtain the right to speak is given from the multi-party communication server, the identification information output section outputs the identification information and the speech content accumulation section accumulates speech contents, while after completing the output by the identification information output section, the speech content accumulation section outputs the accumulated speech contents following the identification information output.

3. The multi-party communication system according to claim 1,
wherein the speech right management section, after completion of output by the speech content accumulation section, requests the multi-party communication server to cancel the right to speak acquired.

4. The multi-party communication system according to claim 1,
wherein the terminal devices each include voice data synthesizing section that synthesizes the voice data of the identification information output by the identification information output section with the voice data of the speech contents accumulated by the speech content accumulation section.

5. A terminal device communicating with other terminal devices and obtaining a right to speak from a multi-party communication server, comprising:
an identification information output section that outputs identification information of a speaking party as voice data;
a speech content accumulation section that accumulates contents of talk as data converted from voice; and
a speech right management section that makes a request to acquire the right to speak and a request to cancel the acquired right to speak;
wherein the speech right management section controls timing of: output from the identification information output section; accumulation by the speech content accumulation section; and a request to cancel the right to speak.

6. The terminal device according to claim 5,
wherein the speech right management section performs a control operation in such a manner that after a permission to acquire the right to speak is granted from the multi-party communication server, the identification information output section outputs the identification information and the speech content accumulation section accumulates the speech contents, while after completing output by the identification information output section, the speech content accumulation section outputs the accumulated speech contents following the identification information output.

7. The terminal device according to claim 5,
wherein the speech right management section, after completion of output by the speech content accumulation section, requests the multi-party communication server to cancel the right to speak acquired.

8. The terminal device according to claim 5,
wherein the terminal devices each include voice data synthesizing section that synthesizes the voice data of the identification information output by the identification information output section with the voice data of the speech contents accumulated by the speech content accumulation section.

9. A multi-party communication method for a multi-party communication system including a multi-party communication server for controlling a speech right acquisition request from a terminal device and a plurality of the terminal devices for carrying out the multi-party communication with a permission to acquire a right to speak from the multi-party communication server, the method comprising:
an identification information output step of outputting the identification information on a speaking party as voice data;
a speech content accumulation step of accumulating contents of talk as data converted from voice; and
a speech right management step of requesting acquisition of the right to speak, and cancellation of the right to speak;
wherein the speech right management step controls timing of: output of the identification information output step; accumulation in the speech content accumulation step; and the speech right cancel request.

10. The multi-party communication method according to claim 9,
wherein the control operation is performed in the speech right management step in such a manner that after a permission to acquire the right to speak is granted from the multi-party communication server, the identification information is output in the identification information output step and the contents of talk are accumulated in the speech content accumulation step, while after completing output in the identification information output step, the contents are output in the speech content accumulation step following the identification information output.

11. The multi-party communication method according to claim 9,
wherein after completion of the output in the speech content accumulation step, the multi-party communication server is requested to cancel the right to speak in the speech right management step.

12. The multi-party communication method according to claim 9, further comprising a voice data synthesizing step of synthesizing the voice data of the identification information output by the identification information output step with the voice data of the contents accumulated in the speech content accumulation step.

13. A computer program causing terminal devices to perform the multi-party communication method described in claim 9.

14. A recording medium recording the computer program described in claim 13.

15. A computer program causing terminal devices to perform the multi-party communication method described in claim 10.

16. A computer program causing terminal devices to perform the multi-party communication method described in claim 11.

17. A computer program causing terminal devices to perform the multi-party communication method described in claim 12.
